(19) United States
(12) Patent Application Publication
(10) Pub. No.: US 2026/0343315 A1
(43) Pub. Date: Oct. 29, 2026

(54) QUALITY OF SERVICE PROCESSING METHOD AND APPARATUS, COMPUTER-READABLE MEDIUM, AND ELECTRONIC DEVICE

(71) Applicant: Tencent Technology (Shenzhen) Company Limited, Shenzhen (CN)

(72) Inventor: Yixue LEI, Shenzhen (CN)

(73) Assignee: Tencent Technology (Shenzhen) Company Limited, Shenzhen (CN)

(21) Appl. No.: 19/673,723

(22) Filed: May 11, 2026

Related U.S. Application Data
(63) Continuation of application No. PCT/CN2024/133621, filed on Nov. 21, 2024.

(30) Foreign Application Priority Data
Dec. 29, 2023 (CN) 202311870077.X

(51) Int. Cl. H04W 28/02; H04W 8/26; H04W 12/06; H04W 28/06; H04W 28/24; H04W 84/12

(52) U.S. Cl. CPC H04W 28/0268; H04W 8/26; H04W 12/06; H04W 28/06; H04W 28/24; H04W 84/12

(57) ABSTRACT

Embodiments of this application provide a quality of service processing method and apparatus, a computer-readable medium, and an electronic device. The quality of service processing method is performed by a terminal device accessed to a core network through an access network element, the terminal device is in communication connection with a service processing device, the service processing device performs service interaction with a service server through the terminal device, and the quality of service processing method includes: establishing a protocol data unit session with the core network; obtaining QoS rule information for the service processing device to transmit a service data packet with the service server based on the PDU session; and performing QoS processing on a service data packet transmission process between the service processing device and the service server based on the QoS rule information.

### RELATED APPLICATION

This application is a continuation of International Patent Application No. PCT/CN2024/133621, filed Nov. 21, 2024, which claims priority to Chinese Patent Application No. 202311870077.X, entitled "QUALITY OF SERVICE PROCESSING METHOD AND APPARATUS, COMPUTER-READABLE MEDIUM, AND ELECTRONIC DEVICE", and filed with the China National Intellectual Property Administration on Dec. 29, 2023. The contents of International Patent Application No. PCT/CN2024/133621 and Chinese Patent Application No. 202311870077.X are each incorporated by reference herein in their entirety.

### FIELD OF THE TECHNOLOGY

This application relates to the field of computer and communication technologies, and specifically, to a quality of service processing method and apparatus, a computer-readable medium, and an electronic device.

### BACKGROUND OF THE DISCLOSURE

In a 5th-generation (5G) mobile communication technology and subsequent evolved systems (such as 5G-A and 6G), high-bandwidth interactive services are important service types, such as cloud gaming, virtual reality (VR), augmented reality (AR), mixed reality (MR), extended reality (XR), cinematic reality (CR), XR and media services (XRM). These high-bandwidth interactive services have a very high requirement on transmission timeliness and have a very large data volume. Therefore, packets of these services have a higher requirement on quality of service (QoS) control during transmission.

In addition, the foregoing processing device of the interactive service is not limited to a radio access technology (RAT) defined by the 3rd generation partnership project (3GPP), but also supports an indirect access manner through another terminal. For example, a service processing device is connected to user equipment (UE) in a Tether manner, and the UE is accessed to a core network through a base station. In this case, how to ensure a QoS requirement of the interactive service is a technical problem to be resolved urgently.

### SUMMARY

Embodiments of this application provide a quality of service processing method and apparatus, a computer-readable medium, and an electronic device, so that a service processing device that does not directly access a core network supports a QoS mechanism, thereby facilitating improving utilization of network bandwidth and service processing quality.

Another feature and advantage of this application is apparent from the following detailed description, or may be learned partially by practice of this application.

According to a first aspect, an embodiment of this application provides a QoS processing method, the QoS processing method being performed by a terminal device accessed to a core network through an access network element, the terminal device being in communication connection with a service processing device, the service processing device performing service interaction with a service server through the terminal device, and the QoS processing method including: establishing a protocol data unit (PDU) session with the core network; obtaining QoS rule information for the service processing device to transmit a service data packet with the service server based on the PDU session; and performing QoS processing on a service data packet transmission process between the service processing device and the service server based on the QoS rule information.

According to a second aspect, an embodiment of this application provides a QoS processing method, the QoS processing method being performed by an application function network element, and the QoS processing method including: generating QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; and transmitting the QoS requirement information to a policy control function network element, to enable the policy control function network element to generate, based on the QoS requirement information, QoS policy information corresponding to the service data packet.

According to a third aspect, an embodiment of this application provides a QoS processing method, the QoS processing method being performed by a policy control function network element, and the QoS processing method including: obtaining QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; generating, based on the QoS requirement information, QoS policy information corresponding to the service data packet; and transmitting the QoS policy information to a session management function network element, to enable the session management function network element to configure QoS processing-related information to a processing device of the service data packet based on the QoS policy information.

In some embodiments of this application, based on the foregoing solution, the generating, based on the QoS requirement information, QoS policy information corresponding to the service data packet includes at least one of the following manners:
obtaining latency information between the terminal device and the service processing device, and generating the QoS policy information based on the QoS requirement information and the latency information; and
generating the QoS policy information based on a manner of reporting a QoS monitoring result and a QoS parameter included in the QoS requirement information, the manner of reporting the QoS monitoring result including:
   combining monitoring results of a plurality of links for reporting or respectively reporting the monitoring results of the plurality of links.

According to a fourth aspect, an embodiment of this application provides a QoS processing method, the QoS processing method being performed by a session management function network element, and the QoS processing method including: receiving QoS policy information that is transmitted by a policy control function network element and that is configured for processing a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; generating, based on the QoS policy information, QoS processing-related information corresponding to each processing device of the service data packet; and configuring the QoS processing-related information to the processing device of the service data packet.

In some embodiments of this application, based on the foregoing solution, the generating, based on the QoS policy information, QoS processing-related information corresponding to each processing device of the service data packet includes at least one of the following manners:
generating QoS configuration information for the access network element based on a load that is received by the terminal device and that is of an uplink service data packet transmitted by the service processing device, the QoS configuration information being configured for indicating the access network element to configure a wireless transmission resource matching the load to the terminal device;
generating QoS configuration information for the access network element based on whether the terminal device has a data packet set processing capability, the QoS configuration information being configured for indicating whether the access network element performs downlink processing on a data packet set;
generating QoS rule information for the terminal device based on the load that is received by the terminal device and that is of the uplink service data packet transmitted by the service processing device, the QoS rule information being configured for configuring the wireless transmission resource matching the load to the terminal device;
obtaining latency information between the terminal device and the service processing device, and generating the QoS processing-related information based on the QoS policy information and the latency information; and
generating the QoS rule information for the terminal device based on a manner of reporting a QoS monitoring result and a QoS parameter included in the QoS policy information, the manner of reporting the QoS monitoring result including:
   combining monitoring results of a plurality of links for reporting or respectively reporting the monitoring results of the plurality of links.

According to a fifth aspect, an embodiment of this application provides a QoS processing apparatus, the QoS processing apparatus being used in a terminal device accessed to a core network through an access network element, the terminal device being in communication connection with a service processing device, the service processing device performing service interaction with a service server through the terminal device, and the QoS processing apparatus including: an establishment unit, configured to establish a PDU session with the core network; an obtaining unit, configured to obtain QoS rule information for the service processing device to transmit a service data packet with the service server based on the PDU session; and a processing unit, configured to perform QoS processing on a service data packet transmission process between the service processing device and the service server based on the QoS rule information.

According to a sixth aspect, an embodiment of this application provides a QoS processing apparatus, the QoS processing apparatus being used in an application function network element, and the QoS processing apparatus including: a generation unit, configured to generate QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; and a transmitting unit, configured to transmit the QoS requirement information to a policy control function network element, to enable the policy control function network element to generate, based on the QoS requirement information, QoS policy information corresponding to the service data packet.

According to a seventh aspect, an embodiment of this application provides a QoS processing apparatus, the QoS processing apparatus being used in a policy control function network element, and the QoS processing apparatus including: an obtaining unit, configured to obtain QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; a generation unit, configured to generate, based on the QoS requirement information, QoS policy information corresponding to the service data packet; and a transmitting unit, configured to transmit the QoS policy information to a session management function network element, to enable the session management function network element to configure QoS processing-related information to a processing device of the service data packet based on the QoS policy information.

According to an eighth aspect, an embodiment of this application provides a QoS processing apparatus, the QoS processing apparatus being used in a session management function network element, and the QoS processing apparatus including: a receiving unit, configured to receive QoS policy information that is transmitted by a policy control function network element and that is configured for processing a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; a generation unit, configured to generate, based on the QoS policy information, QoS processing-related information corresponding to each processing device of the service data packet; and a configuration unit, configured to configure the QoS processing-related information to the processing device of the service data packet.

According to a ninth aspect, an embodiment of this application provides a computer-readable medium, having a computer program stored therein, the computer program, when executed by a processor, implementing the QoS processing method according to the foregoing embodiments.

According to a tenth aspect, an embodiment of this application provides an electronic device, including one or more processors; and a storage apparatus, configured to store one or more computer programs, the one or more computer programs, when executed by the one or more processors, causing the electronic device to implement the QoS processing method according to the foregoing embodiments.

According to an eleventh aspect, an embodiment of this application provides a computer program product, the computer program product including a computer program, and the computer program being stored in a computer-readable storage medium. The processor of the electronic device reads the computer program from the computer-readable storage medium and executes the computer program, to enable the electronic device to perform the QoS processing method provided in the foregoing various exemplary embodiments.

In technical solutions provided in some embodiments of this application, after a terminal device is accessed to a core network through an access network element, a service processing device establishes a communication connection with the terminal device, to perform service interaction with a service server through the terminal device. In this system architecture, the terminal device establishes a PDU session with the core network, obtains QoS rule information for the service processing device to transmit a service data packet with the service server based on the PDU session, and performs QoS processing on a service data packet transmission process between the service processing device and the service server based on the QoS rule information, so that a service processing device that does not directly access the core network supports a QoS mechanism based on the terminal device, thereby improving service data packet processing flexibility on a premise of ensuring a QoS requirement of the service data packet, and facilitating improving network bandwidth utilization and service processing quality.

The foregoing general descriptions and the following detailed descriptions are only illustrative and explanatory, and do not limit this application.

### BRIEF DESCRIPTION OF THE DRAWINGS

FIG. 1 is a schematic diagram of an exemplary system architecture to which a technical solution of embodiments of this application is applicable.

FIG. 2 is a schematic diagram of a transmission process of a multimedia data packet according to an embodiment of this application.

FIG. 3 is a flowchart of a QoS processing method according to an embodiment of this application.

FIG. 4 is a flowchart of a QoS processing method according to an embodiment of this application.

FIG. 5 is a flowchart of a QoS processing method according to an embodiment of this application.

FIG. 6 is a flowchart of a QoS processing method according to an embodiment of this application.

FIG. 7 is a system architectural diagram of connecting a service processing device to a terminal device according to an embodiment of this application.

FIG. 8 is a system architectural diagram of connecting a service processing device to a terminal device according to an embodiment of this application.

FIG. 9A is a flowchart of implementing QoS processing based on a trusted WLAN according to an embodiment of this application.

FIG. 9B is a flowchart of implementing QoS processing based on a WLAN that is not authenticated as trusted according to an embodiment of this application.

FIG. 10 is a flowchart of QoS monitoring according to an embodiment of this application.

FIG. 11 is a block diagram of a QoS processing apparatus according to an embodiment of this application.

FIG. 12 is a block diagram of a QoS processing apparatus according to an embodiment of this application.

FIG. 13 is a block diagram of a QoS processing apparatus according to an embodiment of this application.

FIG. 14 is a block diagram of a QoS processing apparatus according to an embodiment of this application.

FIG. 15 is a schematic structural diagram of a computer system suitable for implementing an electronic device according to the embodiments of this application.

### DESCRIPTION OF EMBODIMENTS

Example implementations are described in a more comprehensive manner with reference to the drawings. However, the example implementations may be implemented in various manners, and cannot be understood as limited to these examples. On the contrary, an objective of these implementations is provided to make this application more comprehensive and complete, and fully conveys concepts of the example implementations to a person skilled in the art.

In addition, features, structures, or characteristics described in this application may be combined in any appropriate manner in any one or more embodiments. In the following description, a plurality of specific details are provided to provide a fully understanding of embodiments of this application. However, a person skilled in the art may understand that when implementing the technical solutions of this application, not all detailed features in embodiments may be used, one or more specific details may be omitted, or another method, component, apparatus, operation, and the like may be used.

In the embodiments of this application, the term "module" or "unit" refers to a computer program having a pre-determined function or a part of a computer program, and operates together with other relevant parts to achieve a pre-determined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Block diagrams shown in the figures are functional entities only and do not necessarily correspond to physically separate entities. To be specific, these functional entities may be implemented in a form of software, or these functional entities may be implemented in one or more hardware modules or integrated circuits, or these functional entities may be implemented in different networks and/or processor apparatuses and/or microcontroller apparatuses.

Flowcharts shown in the drawings are only examples for description, do not necessarily include all contents and operations/steps, and are not necessarily executed in a described sequence. For example, some operations/steps may also be decomposed, and some operations/steps may be merged or partially merged, so an actual sequence of execution may change based on an actual situation.

The "plurality" mentioned in this disclosure refers to two or more. The term "and/or" in this specification is an association relationship for describing associated objects, and represents that three relationships may exist. For example, A and/or B may represent the following three cases: Only A exists, both A and B exist, and only B exists. The character "/" generally indicates an "or" relationship between the associated objects.

With the development of 5G and subsequent evolved systems (such as 5G-A and 6G), a plurality of multimedia services that require a large amount of data and a short delay are applied, for example, a cloud gaming service and interactive services such as VR, AR, MR, XR, and CR.

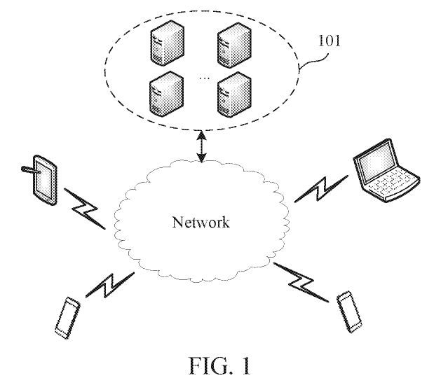

For example, in a cloud gaming scenario shown in FIG. 1, a cloud server 101 is configured to run cloud gaming. The cloud server 101 may render a game image, encode an audio signal and a rendered image, and finally transmit encoded data obtained through encoding to each game client through a network. The game client may be user equipment (UE) having a basic streaming media playback capability, a human-computer interaction capability, a communication capability, and the like, for example, a smart phone, a tablet computer, a laptop computer, a desktop computer, a smart television, a smart appliance, an on board terminal, and an aircraft. Alternatively, the game client may be an application running in a terminal device. Specifically, the game client may decode the encoded data transmitted by the cloud server 101, to obtain a stimulated audio and video signal, and play the stimulated audio and video signal.

FIG. 1 is merely a system architecture that represents a cloud gaming system, and does not limit a specific system architecture of the cloud gaming system. For example, in other embodiments, the cloud gaming system may further include a back-end server for scheduling, and the like. In addition, the cloud server 101 may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The game client and the cloud server 101 may be connected directly or indirectly in a wired or wireless communication manner. This is not limited in this application.

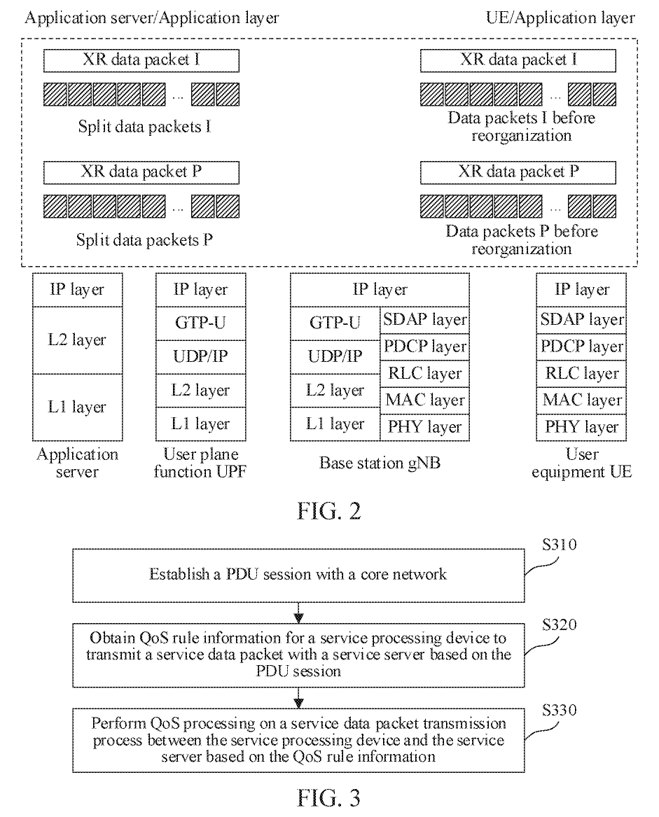

In various interactive service application scenarios based on the multimedia, because a multimedia data packet is large, the multimedia data packet needs to be split into a plurality of data packets for transmission during transmission. Specifically, as shown in FIG. 2, using a 5G system as an example, a user plane mainly includes an application server, a user plane function (UPF), a next generation nodeB (gNB), and UE. For some typical service scenarios, a multimedia data packet is transmitted mainly in a downlink direction, for example, from an application server (AS) to the UPF, and then is transmitted to the UE through the gNB. During transmission, the multimedia data packet (for example, an XR data packet in FIG. 2) is split in an application layer of the application server. After split data packets as internet protocol (IP) packets are transmitted from the application server to the UPF, the 5G system transmits sub data packets to a UE end through a PDU session, submits and reorganizes the multimedia data packets from a protocol stack to recover the multimedia data packets in the UE end.

In the system in FIG. 2, an L1 layer is a physical layer, and is configured to ensure that original data may be transmitted on various physical media; an L2 layer is a data link layer, and the data link layer provides a service to a network layer based on a service provided by the physical layer; an IP layer is the network layer, and is configured to implement data transmission between two end systems; a UDP is a user datagram protocol; a GTP-U is a general packet radio service (GPRS) tunneling protocol-user plane; the PHY is a short for physical, and is the physical layer; a MAC is a media access control; an RLC is a radio link control protocol; a PDCP is a packet data convergence protocol; and an SDAP is a service data adaptation protocol.

As described above, for a multimedia service (such as an XRM service), it is very common to divide a multimedia data packet into a plurality of data packets for transmission. A data packet formed by a single multimedia service frame or a group of packets (GoP) may have a large byte quantity, and needs to be carried by a series of IP packets. There is a specific correlation between these IP data packets, and a wireless network bandwidth may be saved by processing these packets based on the correlation.

For example, it is assumed that data transmission is performed through a plurality of IP packets, the plurality of IP packets may form a PDU set. If some data packets in the PDU set are lost, an entire frame, the GoP, or another video content cannot be decoded, and remaining data in the PDU set is meaningless to a decoding side. However, if an application layer forward error correction (FEC) or another mechanism is introduced, and the media application layer has a packet loss recovery capability or a packet loss concealment capability, after some packets are discarded, remaining data in the PDU set may still be recovered for decoding, and it indicates that the remaining data in the PDU set is still meaningful for decoding at a receiving end.

In addition, in a QoS processing mechanism, if different PDU sets are distinguished for correlation of an application layer data packet, a PDU set that has a high rate but can tolerate a proportion of a packet loss rate or a latency exceeding rate may continue to be processed. In other words, a multimedia service processing manner may be more flexible. In addition, when the multimedia service is processed, a service processing device that is accessed through a RAT defined by the 3GPP organization is not limited, and a service processing device that is not accessed through the 3GPP RAT may be alternatively supported. This is because in an actual scenario, the service processing device may not have a capability of the 3GPP RAT, or may not be directly accessed through the 3GPP RAT, but may be accessed through another UE in a Tether manner. In this case, how to ensure a QoS requirement of the multimedia service during processing (especially, when the multimedia service is transmitted in a PDU set manner) is a technical problem that needs to be resolved urgently.

Based on the foregoing problem, the technical solution in the embodiments of this application provides a new QoS processing solution, so that a service processing device that does not directly access a core network may support a QoS mechanism based on a terminal device, thereby improving service data packet processing flexibility on a premise of ensuring a QoS requirement of a service data packet, facilitating improving network bandwidth utilization and service processing quality, and better dealing with a high-bandwidth interactive service to wireless network transmission.

The following describes implementation of the technical solutions in detail in embodiments of this application.

FIG. 3 is a flowchart of a QoS processing method according to an embodiment of this application. The QoS processing method may be performed by a terminal device accessed to a core network through an access network element. The terminal device is in communication connection with a service processing device, and the service processing device performs service interaction with a service server through the terminal device. Alternatively, the technical solution of the embodiment shown in FIG. 3 may be performed by another network element or device having a similar function. Referring to FIG. 3, the QoS processing method includes at least S310 and S320, which are described in detail as follows.

S310: Establish a PDU session with the core network.

In some exemplary embodiments, that the terminal device executes the technical solution of the embodiment shown in FIG. 3 is used as an example for description. The terminal device may transmit a PDU session establishment request to an access network element (for example, a base station), to initiate a PDU session establishment process, then the access network element may transmit the PDU session establishment request to an access and mobility management function (AMF), and the AMF performs the PDU session establishment process. For example, the AMF performs selection of a session management function (SMF) and initiates creation of a session management context request, and then establishes a PDU session between the terminal device and a core network element through interaction between network elements such as the SMF, the AMF, and a policy control function (PCF).

In some embodiments, after the PDU session is established, the service processing device may transmit data based on a user plane between the terminal device and the service server. Specifically, the service server may transmit a downlink service data packet to be transmitted to the service processing device to the terminal device through the user plane, and then the terminal device transmits the downlink service data packet to the service processing device connected to the terminal device. The service processing device may transmit an uplink service data packet to be transmitted to the service server to the terminal device, and then the terminal device transmits the uplink service data packet to the service server through the user plane.

The service processing device and the terminal device in this embodiment of this application may both be a smartphone, a tablet computer, a notebook computer, a desktop computer, a smart television, a smart household, an in-vehicle terminal, an aircraft, or the like. The service processing device may not support the 3GPP RAT, but be connected to the terminal device in another manner (such as Wi-Fi), or the service processing device may alternatively be a device supporting the 3GPP RAT.

In some exemplary embodiments, the terminal device may be used as an access point to establish a wireless local area network (WLAN), and then at least one service processing device may be accessed to the wireless local area network, to further establish a communication connection between the terminal device and the at least one service processing device.

In some exemplary embodiments, after establishing the wireless local area network, the terminal device may register the wireless local area network with the core network, to authenticate the wireless local area network as a trusted wireless local area network. Alternatively, the wireless local area network established by the terminal device may also be used as a wireless local area network that is not authenticated as trusted, and the terminal device is accessed to the core network through the access network element. The wireless local area network that is not authenticated as trusted refers to that the wireless local area network is not authenticated as trusted. In this case, the core network may be considered as an untrusted wireless local area network. In other words, in this embodiment of this application, the wireless local area network established by the terminal device not only may be used as a trusted wireless local area network, but also may not be used as a trusted wireless local area network for authentication.

In some exemplary embodiments, after the terminal device establishes the wireless local area network, if the service processing device is connected to the wireless local area network, the terminal device may allocate a network address to the service processing device, so that the service processing device transmits a service data packet with the service server based on the allocated network address. In some embodiments, the network address may be an internet protocol (IP) address.

In some exemplary embodiments, after receiving the service data packet transmitted by the service processing device to the service server, the terminal device may further perform translation processing on a network address in the service data packet, to obtain a translated service data packet, and then transmit the translated service data packet to the service server through the PDU session. In other words, in this embodiment, the terminal device has a network address translation (NAT) function. In this way, the service processing device may be shielded from the user plane. In this case, when receiving a downlink service data packet transmitted by the service server to a network address, the terminal device may determine, based on a network address of the downlink service data packet, which service processing device the downlink service data packet needs to be transmitted to, and then forward the downlink service data packet to the service processing device.

In some exemplary embodiments, when receiving the downlink service data packet from the service server, the terminal device may select, based on a priority of the downlink service data packet, a wireless local area network QoS mechanism corresponding to the priority of the downlink service data packet, to transmit the downlink service data packet to the service processing device. In some embodiments, a high-priority service data packet may be made to contend for a radio channel in priority; or a high-priority service data packet may be transmitted in priority; or a transmission rate of a high-priority service data packet is increased, and a transmission rate of a low-priority service data packet is decreased. The high priority and the low priority in this embodiment are relative, and a priority of the high-priority service data packet is greater than a priority of the low-priority service data packet.

In some exemplary embodiments, when establishing the PDU session with the core network, the terminal device may establish one PDU session with the core network. In this case, if there are a plurality of service processing devices, service data packets of different service processing devices may correspond to different QoS flows in the PDU session, to respectively satisfy QoS requirements of the service data packets of different service processing devices.

In some exemplary embodiments, when establishing the PDU session with the core network, the terminal device may respectively establish PDU sessions corresponding to the service data packets of different service processing devices with the core network. In this case, if there are the plurality of service processing devices, the service data packets of different service processing devices may correspond to different PDU sessions, so that the QoS requirements of the service data packets of different service processing devices may also be respectively satisfied.

In some exemplary embodiments, when establishing the PDU session with the core network, the terminal device may establish one PDU session with the core network. In this case, if there are the plurality of service processing devices, the service data packets of different service processing devices may correspond to the same QoS flow in the PDU session. In this way, complexity of QoS processing may be reduced.

In some exemplary embodiments, the service data packet between the service processing device and the service server may be transmitted in a form of a data packet set (that is, a PDU set), or may be transmitted in a per-packet form.

In addition to establishing a connection to the terminal device through the wireless local area network, the service processing device may also establish a connection to the terminal device through another short distance wireless communication technology, for example, may establish a connection to the terminal device through Bluetooth, ZigBee, or the like.

In addition, even if the wireless local area network established by the terminal device is not used as a trusted wireless local area network for authentication, related processing procedures (such as IP address allocating, NAT processing, and QoS processing) are similar to processing procedures in which trusted WLAN authentication is performed.

S320: Obtain QoS rule information for the service processing device to transmit the service data packet with the service server based on the PDU session.

In some exemplary embodiments, a process in which the terminal device obtains the QoS rule information may be: The AF generates QoS requirement information for the service data packet, and transmits the QoS requirement information to the PCF; the PCF generates QoS policy information for the service data packet based on the QoS requirement information, and transmits the QoS policy information to the SMF; and the SMF configures QoS processing-related information for a processing device of the service data packet based on the QoS policy information, where the QoS processing-related information corresponding to the terminal device is the foregoing QoS rule information.

In some possible implementations, after generating the QoS rule information for the terminal device, the SMF transmits the QoS rule information to the AMF, and then the AMF transmits the QoS rule information to the terminal device through the access network element.

In some exemplary embodiments, because the terminal device is not the last hop of end-to-end transmission, that is, after receiving the downlink service data packet transmitted by the service server, the terminal device further needs to transmit the downlink service data packet to the service processing device, and the uplink service data packet that the service processing device needs to transmit to the service server also needs to be transmitted to the terminal device first, when the QoS of the service data packet between the service processing device and the service server is processed, latency information between the terminal device and the service processing device may be considered.

Specifically, the terminal device may obtain the latency information between the terminal device and the service processing device, and then transmit the latency information to a first core network element, so that the PCF generates, based on the latency information obtained from the first core network element, policy information (that is, QoS policy information) configured for performing QoS processing on the service data packet between the service processing device and the service server. That is, when generating the policy information for performing QoS processing, the PCF may consider the latency information between the terminal device and the service processing device. In some embodiments, the first core network element may be a network data analysis function (NWDAF), or may be another network element such as an AMF or an application function (AF).

In some exemplary embodiments, the QoS policy information includes a latency requirement between the service server and the service processing device, and the latency requirement is obtained based on the latency information between the terminal device and the service processing device and latency information between the terminal device and the service server.

In some exemplary embodiments, the latency information (that is, the latency information between the terminal device and the service processing device) transmitted by the terminal device to the first core network element may be uplink transmission latency from the service processing device to the terminal device.

In some exemplary embodiments, the terminal device may monitor an uplink transmission process from the service processing device to the terminal device within a set duration, use an average value of the monitored transmission latency as the uplink transmission latency, and transmit the uplink transmission latency to the first core network element.

In some exemplary embodiments, the terminal device may monitor the uplink transmission process from the service processing device to the terminal device within a set duration, use a maximum value of the monitored transmission latency as the uplink transmission latency, and transmit the uplink transmission latency to the first core network element.

In some exemplary embodiments, the terminal device may monitor the uplink transmission process from the service processing device to the terminal device within a set duration, use a minimum value of the monitored transmission latency as the uplink transmission latency, and transmit the uplink transmission latency to the first core network element.

In some exemplary embodiments, the terminal device may monitor the uplink transmission process from the service processing device to the terminal device a set number of times (for example, once, twice, or more times), use the average value of the monitored transmission latency as the uplink transmission latency, and transmit the uplink transmission latency to the first core network element.

In some exemplary embodiments, the terminal device may monitor the uplink transmission process from the service processing device to the terminal device a set number of times (for example, once, twice, or more times), use the maximum value of the monitored transmission latency as the uplink transmission latency, and transmit the uplink transmission latency to the first core network element.

In some exemplary embodiments, the terminal device may monitor the uplink transmission process from the service processing device to the terminal device a set number of times (for example, once, twice, or more times), use the minimum value of the monitored transmission latency as the uplink transmission latency, and transmit the uplink transmission latency to the first core network element.

A manner of calculating the uplink transmission latency from the service processing device to the terminal device is not limited in the embodiments of this application.

In some exemplary embodiments, the latency information (that is, the latency information between the terminal device and the service processing device) transmitted by the terminal device to the first core network element may be downlink transmission latency from the terminal device to the service processing device.

In some exemplary embodiments, the terminal device may monitor a downlink transmission process from the terminal device to the service processing device within a set duration, use an average value of the monitored transmission latency as the downlink transmission latency, and transmit the downlink transmission latency to the first core network element.

In some exemplary embodiments, the terminal device may monitor the downlink transmission process from the terminal device to the service processing device within a set duration, use a maximum value of the monitored transmission latency as the downlink transmission latency, and transmit the downlink transmission latency to the first core network element.

In some exemplary embodiments, the terminal device may monitor the downlink transmission process from the terminal device to the service processing device within a set duration, use a minimum value of the monitored transmission latency as the downlink transmission latency, and transmit the downlink transmission latency to the first core network element.

In some exemplary embodiments, the terminal device may monitor the downlink transmission process from the terminal device to the service processing device a set number of times (for example, once, twice, or more times), use the average value of the monitored transmission latency as the downlink transmission latency, and transmit the downlink transmission latency to the first core network element.

In some exemplary embodiments, the terminal device may monitor the downlink transmission process from the terminal device to the service processing device a set number of times (for example, once, twice, or more times), use the maximum value of the monitored transmission latency as the downlink transmission latency, and transmit the downlink transmission latency to the first core network element.

In some exemplary embodiments, the terminal device may monitor the downlink transmission process from the terminal device to the service processing device a set number of times (for example, once, twice, or more times), use the minimum value of the monitored transmission latency as the downlink transmission latency, and transmit the downlink transmission latency to the first core network element.

A manner of calculating the downlink transmission latency from the terminal device to the service processing device is not limited in the embodiments of this application.

In some exemplary embodiments, the latency information (that is, the latency information between the terminal device and the service processing device) transmitted by the terminal device to the first core network element may be obtained through calculation based on the uplink transmission latency from the service processing device to the terminal device and the downlink transmission latency from the terminal device to the service processing device.

In some exemplary embodiments, the terminal device may use the average values of the uplink transmission latency and the downlink transmission latency as the latency information between the terminal device and the service processing device.

In some exemplary embodiments, the terminal device may use the maximum values of the uplink transmission latency and the downlink transmission latency as the latency information between the terminal device and the service processing device.

In some exemplary embodiments, the terminal device may use the minimum values of the uplink transmission latency and the downlink transmission latency as the latency information between the terminal device and the service processing device.

A manner of calculating the latency information between the terminal device and the service processing device is not limited in the embodiments of this application.

The uplink transmission latency and the downlink transmission latency in this embodiment may alternatively be obtained based on the manner in the foregoing embodiment, such as by calculating the average value, the maximum value, and the minimum value through monitoring for the set duration or the set number of times, or through a single measurement. This is not limited in the embodiments of this application.

S330: Perform QoS processing on a service data packet transmission process between the service processing device and the service server based on the QoS rule information.

In some exemplary embodiments, the service data packet between the service processing device and the service server may be transmitted in a PDU set manner. In this case, a QoS parameter included in the QoS rule information may be at least one of the following parameters: a PDU Set delay budget (PSDB), a PDU set bit error rate (PSER), a maximum data burst volume (MDBV), a packet delay variation (PDV)/jitter, and the like.

In some embodiments, the service data packet between the service processing device and the service server may not be transmitted in a PDU set manner, but may be transmitted in a per-packet form. In this case, the QoS parameter included in the QoS rule information may be at least one of the following parameters: a packet delay budget (PDB), a packet error rate (PER), a maximum data burst volume, and the like.

In some exemplary embodiments, the process of performing, by the terminal device, QoS processing on the service data packet transmission process between the service processing device and the service server based on the QoS rule information may be performing QoS processing on the uplink service data packet between the service processing device and the service server, or performing QoS processing on the downlink service data packet between the service server and the service processing device.

In some exemplary embodiments, when the terminal device performs QoS processing on the service data packet transmission process between the service processing device and the service server based on the QoS rule information, if the terminal device monitors, based on the QoS rule information, that at least one of the following situations occurs in the service data packet transmission process, the corresponding service data packet is discarded: congestion occurring in the service data packet transmission process, transmission delay information of the service data packet being not capable of satisfying a latency requirement, a bit error rate of the service data packet being not capable of satisfying a bit error rate requirement, and the service data packet being determined as a useless redundant data packet.

Specifically, if monitoring that the transmission delay information of the downlink service data packet from the service server cannot satisfy the latency requirement included in the QoS rule information, the terminal device may discard the downlink service data packet. For a downlink service data packet transmitted in a PDU set manner, the latency requirement included in the QoS rule information is the PSDB. For a downlink service data packet transmitted in a per-packet manner, the latency requirement included in the QoS rule information is the PDB.

In some embodiments, if monitoring that a bit error rate of the downlink service data packet from the service server cannot satisfy the bit error rate requirement included in the QoS rule information, the terminal device may discard the downlink service data packet. For a downlink service data packet transmitted in a PDU set manner, the bit error rate included in the QoS rule information is the PSER. For a downlink service data packet transmitted in a per-packet manner, the bit error rate included in the QoS rule information is the PER.

In some embodiments, if monitoring that congestion of the downlink service data packet from the service server occurs in the transmission process, the terminal device may discard the downlink service data packet. For example, the downlink service data packet may be discarded in descending order of priorities of downlink service data packets.

In some embodiments, if the terminal device monitors that there is a useless redundant data packet in the downlink service data packet from the service server, for example, FEC or another mechanism is used for the downlink service data packet to cause a redundant data packet, and if all valid data packets corresponding to the redundant data packet are normally transmitted, then the redundant data packet is indicated as an invalid data packet, and correspondingly, transmission is not need to be performed, such that discarding processing may be performed.

In some embodiments, if monitoring that the transmission delay information of the uplink service data packet from the service processing device cannot satisfy the latency requirement included in the QoS rule information, the terminal device may discard the uplink service data packet. For an uplink service data packet transmitted in a PDU set manner, the latency requirement included in the QoS rule information is the PSDB. For an uplink service data packet transmitted in a per-packet manner, the latency requirement included in the QoS rule information is the PDB.

In some embodiments, if monitoring that a bit error rate of the uplink service data packet from the service processing device cannot satisfy the bit error rate requirement included in the QoS rule information, the terminal device may discard the uplink service data packet. For an uplink service data packet transmitted in a PDU set manner, the bit error rate included in the QoS rule information is the PSER. For an uplink service data packet transmitted in a per-packet manner, the bit error rate included in the QoS rule information is the PER.

In some embodiments, if monitoring that congestion of the uplink service data packet from the service processing device occurs in the transmission process, the terminal device may discard the uplink service data packet. For example, the uplink service data packet may be discarded in descending order of priorities of uplink service data packets.

In some embodiments, if the terminal device monitors that there is a useless redundant data packet in the uplink service data packet from the service processing device, for example, FEC or another mechanism is used for the uplink service data packet to cause a redundant data packet, and if all valid data packets corresponding to the redundant data packet are normally transmitted, the redundant data packet is indicated as an invalid data packet, and correspondingly, transmission is not need to be performed, such that discarding processing may be performed.

In some exemplary embodiments, the terminal device may determine a priority of the service data packet based on field information included in the service data packet, to discard the service data packet in descending order of priorities when the service data packet needs to be discarded. In some embodiments, the field information may be, for example, PDU set important (PSI) information. Importance of different PDU sets may be determined based on the field information, and the importance is positively correlated to the priority. In another embodiment of this application, the priority of the service data packet may also be determined based on another field information, for example, a type of the service data packet is determined based on a field indicating the type of the service data packet, and then the priority of the service data packet is determined based on predetermined priorities of different types of data packets (for example, it is predetermined that a priority of a video type of the service data packet is higher than a priority of an audio type of the service data packet).

In some exemplary embodiments, because the terminal device further needs to transmit the downlink service data packet to the service processing device after receiving the downlink service data packet transmitted by the service server, and because the uplink service data packet that the service processing device needs to transmit to the service server also needs to be transmitted to the terminal device first, then when the QoS of the service data packet between the service processing device and the service server is processed, the latency information between the terminal device and the service processing device may be considered.

Specifically, when monitoring the transmission delay of the service data packet between the service processing device and the service server, the terminal device may determine, based on the latency information between the terminal device and the service processing device, whether the transmission delay of the service data packet satisfies the latency requirement included in the QoS rule information. For example, a latency requirement of the downlink service data packet transmitted by the service server to the service processing device is 50 ms at most. If the terminal device finds that the downlink service data packet is delayed by 40 ms after receiving the downlink service data packet, and latency between the terminal device and the service processing device is 15 ms, the terminal device may determine that the downlink service data packet cannot satisfy the latency requirement. However, if the terminal device finds that the downlink service data packet is delayed by 40 ms after receiving the downlink service data packet, and the latency between the terminal device and the service processing device is 5 ms, the terminal device may determine that the downlink service data packet may satisfy the latency requirement.

In some exemplary embodiments, when the terminal device monitors that congestion of the service data packet between the service processing device and the service server occurs, the terminal device may further perform explicit congestion notification (ECN) marking on the service data packet (where the service data packet may be the uplink service data packet, or may be the downlink service data packet).

In some embodiments, when the ECN marking is performed on the uplink service data packet, the ECN marking may be set in an IP header of the uplink service data packet, to indicate that the uplink service data packet undergoes network congestion. After the uplink service data packet is transmitted to the service server, the service server learns, based on the ECN marking in the uplink service data packet, that congestion of the uplink service data packet occurs in the transmission process, and then the service server replies an ACK message with an ECN-echo to the service processing device. When receiving the ACK message with the ECN-echo, the service processing device knows that congestion of the uplink service data packet occurs in a network path, and correspondingly adjusts a transmission rate of the uplink service data packet, to avoid further congestion.

In some embodiments, when the ECN marking is performed on the downlink service data packet, ECN marking may be set in an IP header of the downlink service data packet, to indicate that the downlink service data packet undergoes network congestion. After the downlink service data packet is transmitted to the service processing device, the service processing device learns, based on the ECN marking in the downlink service data packet, that congestion of the downlink service data packet occurs in the transmission process, and then the service processing device replies the ACK message with the ECN-echo to the service server. When receiving the ACK message with the ECN-echo, the service server knows that congestion of the downlink service data packet occurs in the network path, and correspondingly adjusts a transmission rate of the downlink service data packet, to avoid further congestion.

In some exemplary embodiments, the terminal device may perform, through low latency, low loss, and scalable throughput (L4S) technologies, transit processing on the service data packet transmitted between the service processing device and the service server.

The low latency refers to that time required for data transmission from a transmission end to a receiving end is as short as possible. The latency refers to time latency in the transmission process, and may affect a response speed and performance of an application program. The low latency technology can may reduce transmission time and improve the response speed and user experience of the application program. The low loss refers to a case that a loss rate of a data packet is as low as possible in a network transmission process. Packet loss refers to a case that some data packets are not successfully transmitted to the receiving end in the network transmission process. A low loss technology may ensure integrity and reliability of data and avoid errors and losses in a data transmission process. The scalable throughput refers to that a data processing capability of a network or a system may be extended according to a requirement. In the scalable throughput technology, the processing capability of the network or the system may be adjusted according to an actual requirement, to ensure efficient operation and scalability of the system.

The technical solution in the embodiments of this application enables the terminal device to implement congestion marking processing based on the L4S technology, thereby helping to reduce the latency, reduce the packet loss rate, and implement scalable throughput. In addition, because congestion marking processing based on the L4S technology provides early congestion feedback, the transmission end can adjust the transmission rate in time, thereby improving performance and stability of the network. In addition, in the embodiments of this application, a service processing device that does not directly access the core network can perform L4S-based congestion processing, thereby facilitating improving network bandwidth utilization and service processing quality.

In some exemplary embodiments, the terminal device may further perform QoS monitoring processing according to the QoS rule, to obtain a QoS monitoring result, where the QoS monitoring result may include at least one of the following: a monitoring result of a communication link between the terminal device and the service processing device, a monitoring result of a communication link between the terminal device and the access network element, or a monitoring result of a core network communication link. Further, the terminal device may transmit the QoS monitoring result to the second core network element. If the QoS monitoring result includes monitoring results of a plurality of links, the terminal device may respectively transmit the monitoring results of the plurality of links to the second core network element, or combine the monitoring results of the plurality of links and then transmit the combined monitoring result to the second core network element. For example, whether to respectively transmit the monitoring results of the plurality of links to the second core network element or to combine the monitoring results of the plurality of links and then transmit the combined monitoring result to the core network element may be determined based on indication information of the second core network element.

In some embodiments, the indication information is configured for indicating a transmitting manner of the link monitoring result.

In some embodiments, the second core network element may be the AMF, the SMF, the PCF, the AF, or another core network element.

In some exemplary embodiments, when performing QoS monitoring, if monitoring that the data transmission rate of the communication link between the terminal device and the access network element is less than or equal to a set value, the terminal device may transmit a notification message to a network element (such as the access network element or the core network element) that performs QoS monitoring processing. If monitoring that the data transmission rate of the communication link between the terminal device and the service processing device is less than or equal to the set value, the terminal device may adjust a communication channel between the terminal device and the service processing device, to adjust the data transmission rate of the communication link between the terminal device and the service processing device.

In some exemplary embodiments, when receiving the service data packet transmitted by the service processing device to the service server, the terminal device may transmit a buffer status report (BSR) to the access network element based on a quantity of received service data packets transmitted by the service processing device, to request the access network element to allocate an uplink transmission resource to the terminal device. For example, if receiving a large quantity of service data packets, the terminal device may request the access network element to allocate a large quantity of uplink transmission resources, to transmit these service data packets to the service server through the access network.

The technical solution in the embodiments of this application is described above from a perspective of the terminal device, and implementation details of the technical solution in the embodiments of this application are further described below from a perspective of another network element.

FIG. 4 is a flowchart of a QoS processing method according to an embodiment of this application. The QoS processing method may be performed by an AF, or may be performed by another network element. Referring to FIG. 4, the QoS processing method includes at least S410 and S420, which are described in detail as follows.

S410: Generate QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device.

In some exemplary embodiments, the service data packet between the service processing device and the service server may be transmitted in a PDU set manner. In this case, a QoS parameter included in the QoS requirement information for the service data packet may be at least one of the following parameters: a PSDB, a PSER, an MDBV, and a PDV.

In some embodiments, the service data packet between the service processing device and the service server may not be transmitted in a PDU set manner, but may be transmitted in a per-packet form. In this case, the QoS parameter included in the QoS requirement information for the service data packet may be at least one of the following parameters: a PDB, a PER, a maximum data burst volume, and the like.

In some exemplary embodiments, when generating the QoS requirement information for the service data packet, the AF may obtain latency information between the terminal device and the service processing device, and then generate the QoS requirement information based on the latency information.

Specifically, as described above, because the terminal device is not the last hop of end-to-end transmission, that is, after receiving a downlink service data packet transmitted by the service server, the terminal device further needs to transmit the downlink service data packet to the service processing device, and an uplink service data packet that the service processing device needs to transmit to the service server also needs to be transmitted to the terminal device first, when QoS of the service data packet between the service processing device and the service server is processed, the latency information between the terminal device and the service processing device may be considered. For example, when generating the QoS requirement information, the AF may consider the latency information. For example, latency requirements on the core network and a wireless access network may be increased based on the latency information, thereby satisfying an end-to-end transmission delay requirement.

In some exemplary embodiments, the AF may alternatively generate the QoS requirement information based on a manner of reporting the QoS parameter and a QoS monitoring result, the manner of reporting the QoS monitoring result including: combining monitoring results of a plurality of links for reporting or respectively reporting the monitoring results of the plurality of links. Specifically, the monitoring results of the plurality of links include: a monitoring result of a communication link between the terminal device and the service processing device, a monitoring result of a communication link between the terminal device and the access network element, and a monitoring result of a core network communication link. The AF may indicate, in the generated QoS requirement information, whether these monitoring results are reported in a combined manner or reported respectively.

S420: Transmit the QoS requirement information to the PCF, to enable the PCF to generate, based on the QoS requirement information, QoS policy information corresponding to the service data packet.

In some exemplary embodiments, when transmitting the QoS requirement information to the PCF, the AF may directly transmit the QoS requirement information to the PCF, or may transmit the QoS requirement information to a network exposure function (NEF), and then the NEF forwards the QoS requirement information to the PCF. Alternatively, the AF may negotiate a service level agreement (SLA) with the PCF, to transfer the QoS requirement information to the PCF.

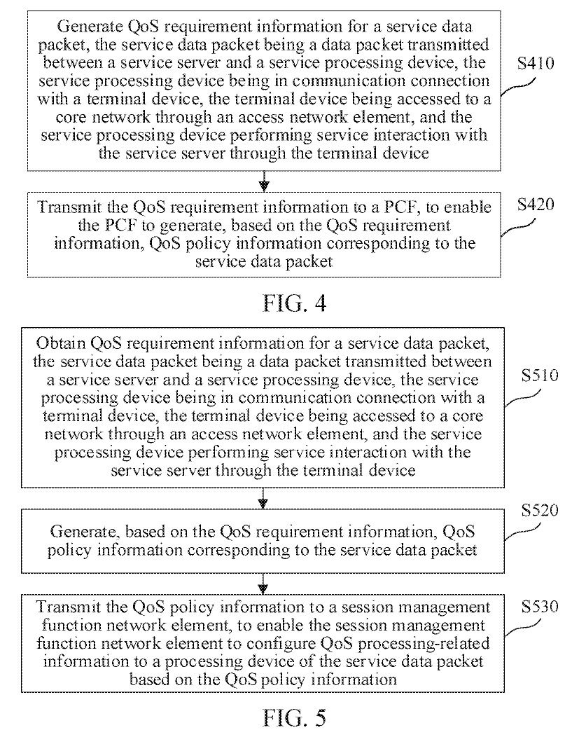

FIG. 5 is a flowchart of a QoS processing method according to an embodiment of this application. The QoS processing method may be performed by a PCF, or may be performed by another network element. Referring to FIG. 5, the QoS processing method includes at least S510 to S530, which are described in detail as follows.

S510: Obtain QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device.

In some exemplary embodiments, the PCF may directly receive the QoS requirement information that is for the service data packet and that is transmitted by the AF, or may receive the QoS requirement information that is forwarded by the NEF and that is from the AF, or the PCF may obtain the QoS requirement information by negotiating the SLA with the AF.

In some exemplary embodiments, the service data packet between the service processing device and the service server may be transmitted in a PDU set manner. In this case, a QoS parameter included in the QoS requirement information for the service data packet may be at least one of the following parameters: a PSDB, a PSER, an MDBV, and a PDV.

In some embodiments, the service data packet between the service processing device and the service server may not be transmitted in a PDU set manner, but may be transmitted in a per-packet form. In this case, the QoS parameter included in the QoS requirement information for the service data packet may be at least one of the following parameters: a PDB, a PER, a maximum data burst volume, and the like.

S520: Generate, based on the QoS requirement information, QoS policy information corresponding to the service data packet.

In some exemplary embodiments, when generating the QoS policy information corresponding to the service data packet, the PCF may obtain latency information between the terminal device and the service processing device, and then generate, based on the latency information and the QoS requirement information, the QoS policy information corresponding to the service data packet.

Specifically, as described above, because the terminal device is not the last hop of end-to-end transmission, that is, after receiving a downlink service data packet transmitted by the service server, the terminal device further needs to transmit the downlink service data packet to the service processing device, and because an uplink service data packet that the service processing device needs to transmit to the service server also needs to be transmitted to the terminal device first, then when QoS of the service data packet between the service processing device and the service server is processed, the latency information between the terminal device and the service processing device may be considered. For example, when generating the QoS policy information, the PCF may consider the latency information. For example, latency requirements on the core network and a wireless access network may be increased based on the latency information, thereby satisfying an end-to-end transmission delay requirement.

In some exemplary embodiments, the PCF may further generate the QoS policy information based on a manner of reporting the QoS monitoring result and the QoS parameter included in the QoS requirement information, the manner of reporting the QoS monitoring result including: combining monitoring results of a plurality of links for reporting or respectively reporting the monitoring results of the plurality of links. Specifically, the monitoring results of the plurality of links include: a monitoring result of a communication link between the terminal device and the service processing device, a monitoring result of a communication link between the terminal device and the access network element, and a monitoring result of a core network communication link. The PCF may indicate, in the generated QoS policy information, whether these monitoring results are reported in a combined manner or reported respectively.

S530: Transmit the QoS policy information to a session management function network element, to enable the session management function network element to configure QoS processing-related information to a processing device of the service data packet based on the QoS policy information.

In some exemplary embodiments, a process in which the PCF transmits the QoS policy information to the SMF may be that the PCF and the SMF interact with each other through a session management policy association establishment (SM Policy Association Establishment) signaling procedure, or interact with each other through a session management policy association modification (SM Policy Association Modification signaling procedure. Then, the PCF transmits the QoS policy information to the SMF through a session management policy context data IE (SM Policy Context Data IE).

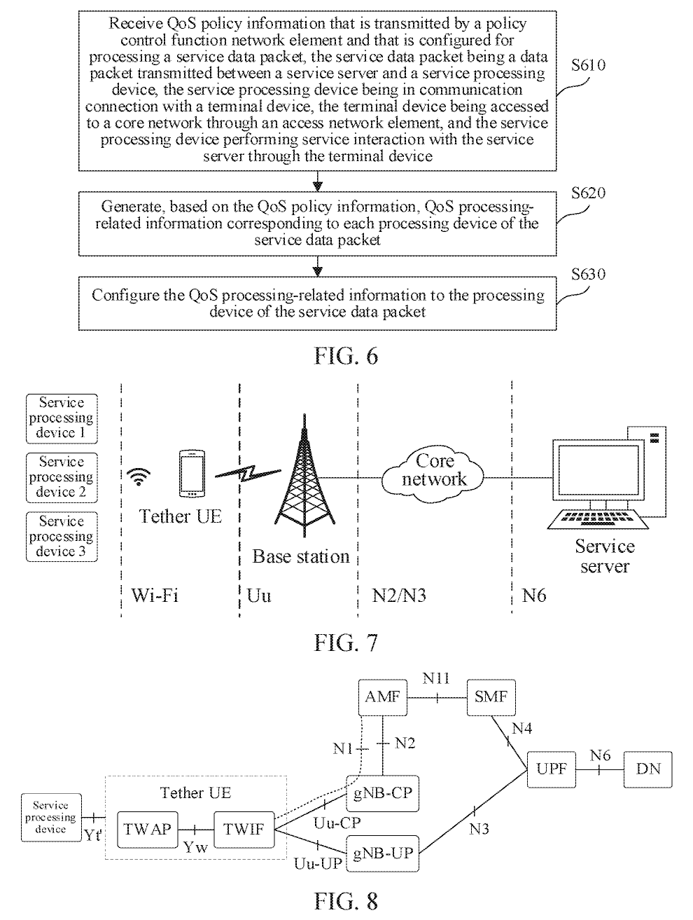

FIG. 6 relates to a process in which the SMF configures the QoS processing-related information to the processing device of the service data packet based on the QoS policy information.

In further detail, FIG. 6 is a flowchart of a QoS processing method according to an embodiment of this application. The QoS processing method may be performed by an SMF, or may be performed by another network element. Referring to FIG. 6, the QoS processing method includes at least S610 to S630, which are described in detail as follows.

S610: Receive QoS policy information that is transmitted by a policy control function network element and that is configured for processing a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device.

In some embodiments, for a generation process of the QoS policy information transmitted by the PCF and related descriptions, reference may be made to the technical solution in the foregoing embodiment. Details are not described again.

S620: Generate, based on the QoS policy information, QoS processing-related information corresponding to each processing device of the service data packet.

In some exemplary embodiments, the SMF may generate first QoS configuration information for the access network element based on a load that is received by the terminal device and that is of an uplink service data packet transmitted by the service processing device, the first QoS configuration information being configured for indicating the access network element to configure a wireless transmission resource matching the load to the terminal device. For example, if the service processing device transmits many uplink service data packets to the terminal device, the first QoS configuration information may indicate the access network element to configure many wireless transmission resources to the terminal device, to improve transmission efficiency of an uplink data packet. If the service processing device transmits fewer uplink service data packets to the terminal device, the first QoS configuration information may indicate the access network element to configure fewer wireless transmission resources to the terminal device, to save an uplink transmission resource.

In some exemplary embodiments, the SMF may generate second QoS configuration information for the access network element based on whether the terminal device has a data packet set processing capability, the second QoS configuration information being configured for indicating whether the access network element performs downlink processing on a data packet set. For example, if the terminal device has the data packet set (that is, a PDU set) processing capability, the terminal device may indicate, through the QoS configuration information, the access network element to perform downlink processing on the data packet set. If the terminal device does not have the processing capability of the data packet set, the terminal device may indicate, through the QoS configuration information, the access network element to transmit a downlink service data packet in a per-packet form.

In some exemplary embodiments, the SMF may generate QoS rule information for the terminal device based on the load that is received by the terminal device and that is of the uplink service data packet transmitted by the service processing device, the QoS rule information being configured for configuring the wireless transmission resource matching the load to the terminal device. For example, if the service processing device transmits many uplink service data packets to the terminal device, many wireless transmission resources may be configured to the terminal device, to improve transmission efficiency of the uplink data packet. If the service processing device transmits fewer uplink service data packets to the terminal device, fewer wireless transmission resources may be configured to the terminal device, to save the uplink transmission resource.

In some exemplary embodiments, the SMF may obtain latency information between the terminal device and the service processing device, and generate the QoS processing-related information based on the QoS policy information and the latency information.

Specifically, as described above, because the terminal device is not the last hop of end-to-end transmission, that is, after receiving the downlink service data packet transmitted by the service server, the terminal device further needs to transmit the downlink service data packet to the service processing device, and because an uplink service data packet that the service processing device needs to transmit to the service server also needs to be transmitted to the terminal device first, when QoS of the service data packet between the service processing device and the service server is processed, the latency information between the terminal device and the service processing device may be considered. For example, when generating the QoS processing-related information, the SMF may consider the latency information. For example, latency requirements on the core network and the wireless access network may be increased based on the latency information, thereby satisfying an end-to-end transmission delay requirement.

In some exemplary embodiments, the SMF may further generate the QoS rule information for the terminal device based on a manner of reporting a QoS monitoring result and a QoS parameter included in the QoS policy information. The manner of reporting the QoS monitoring result includes: combining monitoring results of a plurality of links for reporting or respectively reporting the monitoring results of the plurality of links. Specifically, the monitoring results of the plurality of links include: a monitoring result of a communication link between the terminal device and the service processing device, a monitoring result of a communication link between the terminal device and the access network element, and a monitoring result of a core network communication link. The SMF may indicate, in the generated QoS rule information, whether these monitoring results are reported in a combined manner or reported respectively.

S630: Configure the QoS processing-related information to the processing device of the service data packet.

In some exemplary embodiments, a process of configuring the QoS processing-related information to the processing device of the service data packet may include: transmitting an SDF template to a UPF, transmitting the QoS configuration information to the access network element (for example, a base station), and transmitting the QoS rule information to the terminal device.

In some embodiments, when transmitting the QoS configuration information to the access network element, the SMF may transmit the QoS configuration information to the AMF, and then the AMF transmits the QoS configuration information to the access network element.

In some embodiments, when transmitting the QoS rule information to the terminal device, the SMF may transmit the QoS rule information to the AMF, the AMF transmits the QoS rule information to the access network element, and then the access network element transmits the QoS rule information to the terminal device.

The following describes the implementation details of the technical solution in the embodiments of this application in detail with reference to FIGS. 7-11 by using an example in which a service processing device is accessed to a terminal device through Wi-Fi.

As shown in FIG. 7, the terminal device constructs a WLAN, so that the service processing device can be accessed to the WLAN to establish a communication connection with the terminal device. Further, the terminal device may be used as a Tether device (Tether UE) to implement data exchange between the service processing device and a service server. The Tether UE communicates with a base station (that is, an access network element) through a Uu interface, the base station is accessed to a core network through an N2 interface and an N3 interface, and the core network exchanges data with a service server through an N6 interface.

The Tether device (Tether UE) is merely a representation in one embodiment of this application, and may also be referred to as a convergence device or another representation in another embodiment of this application provided that the Tether device can implement a similar function and fall within the protection scope of this application.

In the example shown in FIG. 7, the Tether UE may be accessed to the core network (for example, accessed to a 5G core network) through the base station. The service processing device may be a device for processing an XRM service (that is, an XRM device), and one or more service processing devices may be connected to the Tether UE. In some embodiments, the service processing device supports a non-access stratum (DNS) protocol module, or may not support a DNS protocol module. This is not limited in the embodiments of this application.

The WLAN established by the Tether UE may be a trusted WLAN, or may not be used as a trusted WLAN for authentication.

In an embodiment of this application, if the WLAN established by the Tether UE is the trusted WLAN, for details of the system architecture diagram shown in FIG. 7, reference may be made to FIG. 8, where the Tether UE may include a trusted WLAN access point (TWAP) and a trusted WLAN interworking function (TWIF). The TWIF may be connected to a control plane of the base station (gNB-CP) and a user plane of the base station (gNB-UP). The gNB-CP interacts with the AMF through the N2 interface, and the gNB-UP interacts with the UPF through the N3 interface. A data network (DN) may be the service server, or the service server may be connected to the data network.

Based on the system architecture shown in FIG. 8, to support a PDU set QoS processing feature of the service processing device accessed based on the Tether UE, the TWAP in the Tether UE may implement transmission of a WLAN message through a Yt' interface, and bear, on the Yt' interface, priorities of different PDU set data packets with WLAN data of different QoS priorities. The TWIF in the Tether UE implements a relaying function of an N3 interface message (that is, implements a relaying function of a user plane message), and is used as an end point of N1 NAS signaling. Data and signaling transmission is performed between the TWIF and the gNB through the Uu interface (signaling is transmitted through Uu-CP, and data is transmitted through Uu-UP).

The Tether UE implements a function of allocating an IP address to the service processing device through at least one of the TWAP or the TWIF, and may provide a NAT processing function, to block the IP address of the service processing device from the user plane.

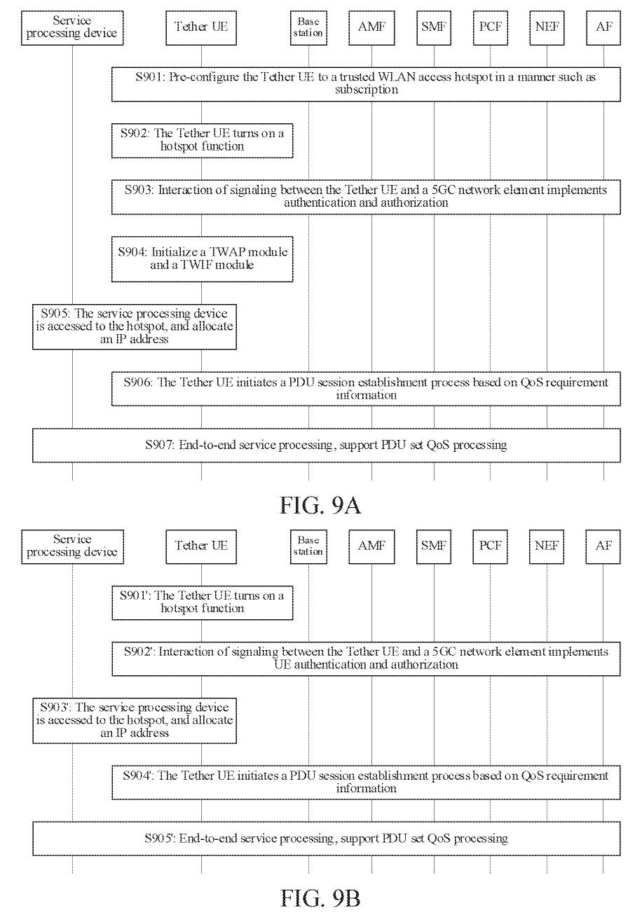

In some embodiments, the Tether UE may register a WLAN access hotspot with the core network, for example, register with a 5G core (5GC) network, so that the Tether UE becomes the trusted WLAN access point and implements an end-to-end cellular+Wi-Fi Tether connection. Using a 5G network as an example, a specific process is shown in FIG. 9A, and includes the following operations.

S901: Pre-configure Tether UE to a trusted WLAN access hotspot in a manner such as subscription.

S902: The Tether UE turns on a hotspot function.

S903: Interaction of signaling between the Tether UE and a 5GC network element implements authentication and authorization on the UE, and because the pre-configured Tether UE may be used as a trusted WLAN hotspot, the Tether UE may be authenticated as a trusted WLAN access point after authentication.

S904: Initialize a TWAP module and a TWIF module.

S905: Allocate an IP address to a service processing device if the service processing device is accessed to the Tether UE.

S906: The Tether UE initiates a PDU session establishment process based on QoS requirement information.

In some embodiments, the Tether UE may establish a PDU session. In this case, if there are a plurality of service processing devices, service data packets of different service processing devices may correspond to different QoS flows in the PDU session, to respectively satisfy QoS requirements of the service data packets of different service processing devices.

In some embodiments, the Tether UE may respectively establish PDU sessions corresponding to the service data packets of different service processing devices. In this case, if there are the plurality of service processing devices, the service data packets of different service processing devices may correspond to different PDU sessions, so that the QoS requirements of the service data packets of different service processing devices may also be respectively satisfied.

In some embodiments, the Tether UE may establish the PDU session with the core network. In this case, if there are the plurality of service processing devices, service data packets of different service processing devices may correspond to the same QoS flow in the PDU session. In this way, complexity of QoS processing may be reduced.

S907: After the PDU session is established, perform end-to-end service processing between a service processing device and a service server (not shown in FIG. 9A), and support PDU set QoS processing.

Alternatively, the WLAN established by the Tether UE may not be used as a trusted WLAN for authentication. In this case, establishment of the PDU session and end-to-end service processing between the service processing device and the service server may also be implemented, and PDU set QoS processing may be supported. In an example, reference may be made to the procedure shown in FIG. 9B, and the following operations are included.

S901': The Tether UE turns on the hotspot function.

S902': Interaction of signaling between the Tether UE and the 5GC network element implements authentication and authorization on the Tether UE. In S902', the 5GC network element authenticates and authorizes the Tether UE, that is, a conventional authentication and authorization process in which the UE is accessed to the core network, but does not authenticate the Tether UE as the trusted WLAN access point. In other words, in this embodiment, the WLAN established by the Tether UE is not authenticated as the trusted WLAN, but another processing procedure is similar to a processing procedure in which trusted WLAN authentication is performed.

S903': Allocate the IP address to the service processing device if the service processing device is accessed to the Tether UE.

S904': The Tether UE initiates the PDU session establishment process based on the QoS requirement information.

In some embodiments, the Tether UE may establish the PDU session. In this case, if there are the plurality of service processing devices, the service data packets of different service processing devices may correspond to different QoS flows in the PDU session, to respectively satisfy the QoS requirements of the service data packets of different service processing devices.

In some embodiments, the Tether UE may respectively establish the PDU sessions corresponding to the service data packets of different service processing devices. In this case, if there are the plurality of service processing devices, the service data packets of different service processing devices may correspond to different PDU sessions, so that the QoS requirements of the service data packets of different service processing devices may also be respectively satisfied.

In some embodiments, the Tether UE may establish the PDU session with the core network. In this case, if there are the plurality of service processing devices, the service data packets of different service processing devices may correspond to the same QoS flow in the PDU session. In this way, complexity of QoS processing may be reduced.

S905': After the PDU session is established, perform end-to-end service processing between the service processing device and the service server, and support PDU set QoS processing.

It may be known with reference to FIGS. 9A and 9B that, the technical solution in the embodiments of this application enables the service processing device to be accessed to the core network by being accessed to a trusted WLAN or a WLAN that is not authenticated as trusted, and may support PDU Set QoS processing based on the trusted WLAN and the WLAN that is not authenticated as trusted.

In some exemplary embodiments, to support PDU set QoS processing, the Tether UE may support the following functions: service flows of the plurality of service processing devices being aggregated at the Tether UE, the Tether UE initiating PDU session establishment to a 5G System (5GS), QoS flow, and the like.

In some embodiments, the Tether UE may identify and mark the PDU set in an uplink direction, to support the gNB to implement PDU set QoS processing. In addition, the Tether UE may initiate a BSR to the gNB based on a data volume generated by the service processing device, to request an uplink transmission resource of the Uu interface.

In some embodiments, in a downlink direction, the Tether UE may further monitor a parameter of the PSDB based on that the gNB performs PDU set QoS processing already. If a data packet that exceeds the PSDB is found, the data packet may be discarded on the Tether UE.

In some exemplary embodiments, the following new functions are introduced to, but not limited to: when the AF generates the QoS requirement and the PCF generates a policy control and charging (PCC) rule, QoS parameter generation optimization is performed with reference to factors such as delay increasing caused by the Tether, including but not limited to: increasing latency requirements on the 5GC+Uu based on a value of delay increasing caused by the Tether, to satisfy an end-to-end delay requirement.

In some embodiments, setting may be performed with reference to a Tether feature when QoS monitoring or ECN marking for L4S is started. For example, performance impact caused by WLAN access may be combined with Uu interface performance, or provided respectively to the AF, the UPF or another core network element.

In some exemplary embodiments, the following new functions may be introduced to, but not limited to the SMF: when configuring QoS configuration information (QoS profile), the QoS rule, and an N4 rule (where the N4 rule is QoS processing-related information transmitted to the UPF), optimization is performed with reference to a Wi-Fi access feature of the Tether UE. Specifically, when the SMF configures the QoS profile to the gNB, with reference to a traffic load of the service data packet carried by the Tether UE, the gNB may be indicated to allocate many wireless transmission resources to the Tether UE carrying more traffic, it is determined whether the gNB performs PDU set downlink processing based on whether the Tether UE has PDU set downlink processing capability, and the like.

In some embodiment, when configuring the QoS rule for the Tether UE, the SMF may allocate, with reference to the traffic load of the service data packet carried by the Tether UE, many wireless transmission resources to the Tether UE carrying more traffic.

In some exemplary embodiments, to implement the QoS monitoring function, the Tether UE may monitor information such as round-trip time (RTT), a data transmission rate (data rate), and congestion according to a rule related to QoS monitoring generated by the core network, and report the information to the core network element (for example, the AF).

In some embodiments, the RTT may be monitored by monitoring the Uu interface and a 5GC latency of the Tether UE, and by considering a latency of a Tether link (that is, a link between the Tether UE and the service processing device). In some embodiments, the latency of the Tether link may be added to a latency of the Uu interface, or may be added to a total latency.

In some embodiments, the data rate may be monitored by monitoring the Uu interface of the Tether UE and a rate bottleneck of the Tether link. If the Tether UE can identify that the rate bottleneck is the Uu interface, the Tether UE may report the rate bottleneck to a network element of the QoS monitoring (for example, the gNB). If a bottleneck of the Tether UE is on the Tether link of the WLAN access, the Tether UE may be resolved by dynamically selecting a channel or in another manner.

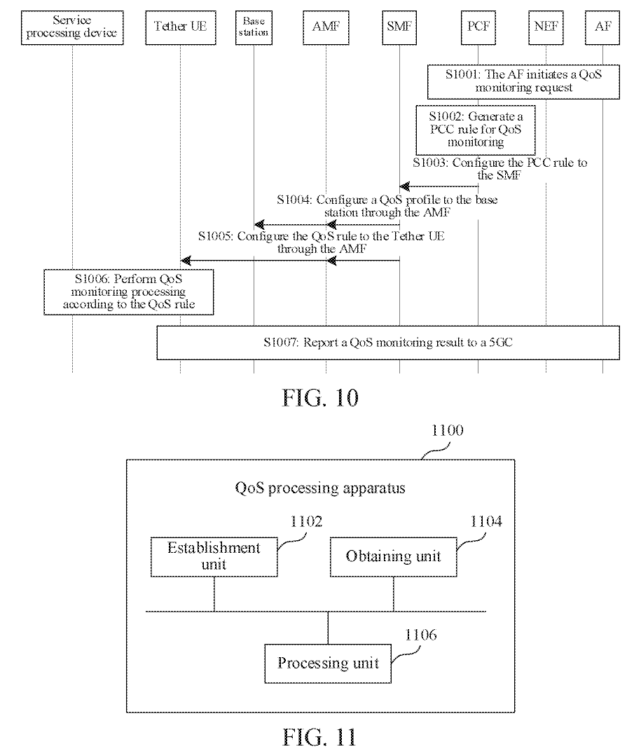

As shown in FIG. 10, a QoS monitoring procedure according to an embodiment of this application may include the following operations.

S1001: An AF initiates a QoS monitoring request.

In some embodiments, the AF may indicate, in the QoS monitoring request, an indicator to be monitored, for example, may indicate to monitor RTT, congestion, or the like.

S1002: A PCF generates a PCC rule for QoS monitoring based on the QoS monitoring request transmitted by the AF.

S1003: The PCF configures the PCC rule to an SMF.

S1004: The SMF generates a QoS profile for a base station, and configures the QoS profile to the base station through an AMF.

S1005: The SMF generates a QoS rule for Tether UE, and configures the QoS rule to the Tether UE through the AMF.

S1006: The Tether UE performs QoS monitoring processing according to the QoS rule.

For example, if the AF indicates to monitor RTT, the Tether UE may perform RTT monitoring, including a latency of a Uu interface, a latency of a Tether link, and the like of the Tether UE. If the AF indicates to monitor congestion, the Tether UE may perform congestion monitoring, including congestion of the Uu interface, congestion of the Tether link, and the like of the Tether UE.

S1007: The Tether UE reports a QoS monitoring result to a 5GC.

In some embodiments, the Tether UE may separately report QoS monitoring results of different links to the 5GC, or may combine the QoS monitoring results and report the combined QoS monitoring result to the 5GC. For example, if the Tether UE monitors the latency of the Uu interface and the latency of the Tether link, the Tether UE may combine the latency of the Uu interface and the latency of the Tether link and report the combined latency to the 5GC, or may separately report the latency of the Uu interface and the latency of the Tether link to the 5GC. For another example, if the Tether UE monitors the congestion of the Uu interface and the congestion of the Tether link, the Tether UE may combine the congestion of the Uu interface and the congestion of the Tether link, and report the combined congestion to the 5GC, or may separately report the congestion of the Uu interface and the congestion of the Tether link to the 5GC.

In conclusion, the technical solution of the embodiments of this application enables the terminal device to establish the wireless local area network, so that the service processing device may be accessed to the core network by being accessed to the wireless local area network. Additionally, supporting of PDU set QoS processing may be provided in the terminal device, including uplink or downlink PDU set processing, the QoS requirement of the service processing device may be obtained, QoS monitoring may be assisted, and the like. In the technical solution of the embodiments of this application, better QoS supporting may be implemented through a PDU set mechanism for a service processing device that does not directly access a cellular network, thereby improving network bandwidth utilization and service processing quality, to better deal with a challenge of a high-bandwidth interactive service to wireless network transmission.

The foregoing embodiment is described by using an example in which the service data is transmitted between the service processing device and the service server in a PDU set manner, and a processing manner in which the service data is transmitted between the service processing device and the service server in a per-packet manner is similar thereto, and details are not described again. In addition, the wireless local area network established by the terminal device may be a trusted wireless local area network, or may be a wireless local area network that is not authenticated as trusted. In addition, in addition to establishing a connection to the terminal device through the Wi-Fi, the service processing device may also establish a connection to the terminal device through another short distance wireless communication technology, for example, may establish a connection to the terminal device through Bluetooth, ZigBee, or the like.

The following describes apparatus embodiments of this application, which may be configured to perform the QoS processing method in the foregoing embodiments of this application, as previously described.

FIG. 11 is a block diagram of a QoS processing apparatus according to an embodiment of this application. The QoS processing apparatus is used in a terminal device accessed to a core network through an access network element, the terminal device is in communication connection with a service processing device, and the service processing device performs service interaction with a service server through the terminal device.

Referring to FIG. 11, a QoS processing apparatus 1100 according to an embodiment of this application includes an establishment unit 1102, an obtaining unit 1104, and a processing unit 1106.

The establishment unit 1102 is configured to establish a protocol data unit PDU session with a core network; the obtaining unit 1104 is configured to obtain QoS rule information for the service processing device to transmit the service data packet with the service server based on the PDU session; and the processing unit 1106 is configured to perform QoS processing on a service data packet transmission process between the service processing device and the service server based on the QoS rule information.

In some embodiments of this application, based on the foregoing solution, the establishment unit 1102 is configured to: establish the PDU session with the core network, service data packets of different service processing devices corresponding to different QoS flows in the PDU session;

respectively establish PDU sessions corresponding to service data packets of different service processing devices with the core network; or

establish the PDU session with the core network, service data packets of different service processing devices corresponding to the same QoS flow in the PDU session.

In some embodiments of this application, based on the foregoing solution, the establishment unit 1102 is further configured to establish, as an access point, a wireless local area network, the wireless local area network being configured to enable at least one service processing device to access, to establish a communication connection between the terminal device and the at least one service processing device.

In some embodiments of this application, based on the foregoing solution, the QoS processing apparatus 1100 further includes an access unit, configured to register the wireless local area network with the core network, to authenticate the wireless local area network as a trusted wireless local area network, or

use a wireless local area network as a wireless local area network that is not authenticated as trusted; and accessing the terminal device to the core network through the access network element.

In some embodiments of this application, based on the foregoing solution, the QoS processing apparatus 1100 further includes: an allocating unit, configured to allocate a network address to the service processing device after the service processing device is connected to the wireless local area network, to enable the service processing device to transmit the service data packet with the service server based on the allocated network address.

In some embodiments of this application, based on the foregoing solution, the processing unit 1106 is further configured to: perform, after the service data packet that is transmitted by the service processing device to the service server is received, translation processing on a network address in the service data packet, to obtain a translated service data packet; and transmit the translated service data packet to the service server through the PDU session.

In some embodiments of this application, based on the foregoing solution, the processing unit 1106 is further configured to: receive a downlink service data packet from the service server; and select, based on a priority of the downlink service data packet, a wireless local area network QoS mechanism corresponding to the priority, to transmit the downlink service data packet to the service processing device.

In some embodiments of this application, based on the foregoing solution, the QoS processing apparatus 1100 further includes a receiving unit, configured to receive an uplink service data packet from the service processing device; and a transmitting unit, configured to transmit a buffer status report to the access network element based on a quantity of uplink service data packets, to request the access network element to allocate an uplink transmission resource to the terminal device

In some embodiments of this application, based on the foregoing solution, the processing unit 1106 is configured to discard the corresponding service data packet in response to a monitoring, based on the QoS rule information, that at least one of the following situations occurs in the service data packet transmission process: congestion occurring in the service data packet transmission process, transmission delay information of the service data packet being not capable of satisfying a latency requirement, a bit error rate of the service data packet being not capable of satisfying a bit error rate requirement, and the service data packet being determined as a useless redundant data packet.

In some embodiments of this application, based on the foregoing solution, the latency requirement is a latency requirement between the service server and the service processing device, and the latency requirement is obtained based on latency information between the terminal device and the service processing device and latency information between the terminal device and the service server.

In some embodiments of this application, based on the foregoing solution, the obtaining unit 1104 is further configured to obtain the latency information between the terminal device and the service processing device; and the processing unit 1106 is configured to, when transmission delay of the service data packet between the service processing device and the service server is monitored, determine, based on the latency information, whether the transmission delay of the service data packet satisfies the latency requirement included in the QoS rule information.

In some embodiments of this application, based on the foregoing solution, the obtaining unit 1104 is further configured to obtain the latency information between the terminal device and the service processing device; and the QoS processing apparatus 1100 further includes a transmitting unit, configured to transmit the latency information to a first core network element, to enable a policy control function network element to generate, based on the latency information obtained from the first core network element, QoS policy information configured for processing the service data packet, where the QoS rule information is obtained based on the QoS policy information.

In some embodiments of this application, based on the foregoing solution, the processing unit 1106 is further configured to perform explicit congestion notification ECN marking on the service data packet in response to a monitoring that congestion of the service data packet between the service processing device and the service server occurs.

In some embodiments of this application, based on the foregoing solution, the processing unit 1106 is further configured to perform QoS monitoring processing according to the QoS rule, to obtain a QoS monitoring result, the QoS monitoring result including at least one of the following: a monitoring result of a communication link between the terminal device and the service processing device, a monitoring result of a communication link between the terminal device and the access network element, and a monitoring result of a core network communication link.

The QoS processing apparatus 1100 further includes a transmitting unit, configured to transmit the QoS monitoring result to a second core network element, if the QoS monitoring result includes monitoring results of a plurality of links, the monitoring results of the plurality of links being respectively transmitted to the second core network element, or the monitoring results of the plurality of links being combined and then the combined monitoring result being transmitted to the second core network element.

In some embodiments of this application, based on the foregoing solution, the processing unit 1106 is further configured to: transmit, in response to a monitoring that a data transmission rate of the communication link between the terminal device and the access network element is less than or equal to a set value, a notification message to a network element performing QoS monitoring processing; and adjust, in response to a monitoring that a data transmission rate of the communication link between the terminal device and the service processing device is less than or equal to the set value, a communication channel between the terminal device and the service processing device.

In some embodiments of this application, based on the foregoing solution, the service data packet between the service processing device and the service server is transmitted through a data packet set.

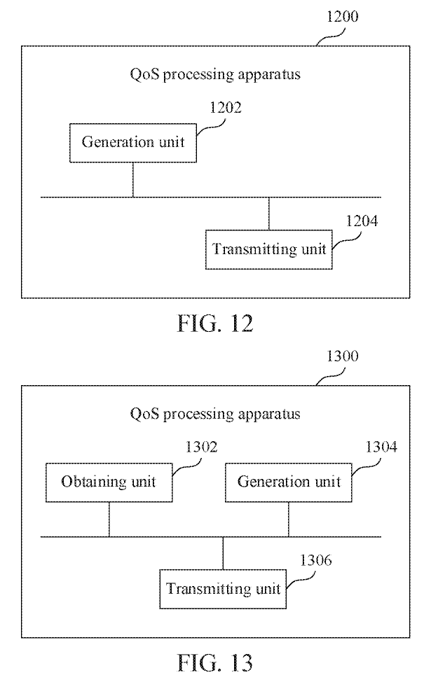

FIG. 12 is a block diagram of a QoS processing apparatus according to an embodiment of this application. The QoS processing apparatus is applied to an AF, or may be applied to another network element.

Referring to FIG. 12, a QoS processing apparatus 1200 according to an embodiment of this application includes a generation unit 1202 and a transmitting unit 1204.

The generation unit 1202 is configured to generate QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; and the transmitting unit 1204 is configured to transmit the QoS requirement information to a policy control function network element, to enable the policy control function network element to generate, based on the QoS requirement information, QoS policy information corresponding to the service data packet.

In some embodiments of this application, based on the foregoing solution, the generation unit 1202 is configured to generate the QoS requirement information for the service data packet in at least one of the following manners:
obtaining latency information between the terminal device and the service processing device, and generating the QoS requirement information based on the latency information; and
generating the QoS requirement information based on a manner of reporting a QoS parameter and a QoS monitoring result, the manner of reporting the QoS monitoring result including:
   combining monitoring results of a plurality of links for reporting or respectively reporting the monitoring results of the plurality of links.

In some embodiments of this application, based on the foregoing solution, the generation unit 1304 is configured to generate the QoS policy information corresponding to the service data packet based on at least one of the following manners:
obtaining latency information between the terminal device and the service processing device, and generating the QoS policy information based on the QoS requirement information and the latency information; and
generating the QoS policy information based on a manner of reporting a QoS monitoring result and a QoS parameter included in the QoS requirement information, the manner of reporting the QoS monitoring result including:
   combining monitoring results of a plurality of links for reporting or respectively reporting the monitoring results of the plurality of links.

FIG. 13 is a block diagram of a QoS processing apparatus according to an embodiment of this application. The QoS processing apparatus is applied to a PCF, or may be applied to another network element.

Referring to FIG. 13, a QoS processing apparatus 1300 according to an embodiment of this application includes an obtaining unit 1302, a generation unit 1304, and a transmitting unit 1306.

The obtaining unit 1302 is configured to obtain QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; the generation unit 1304 is configured to generate, based on the QoS requirement information, QoS policy information corresponding to the service data packet; and the transmitting unit 1306 is configured to transmit the QoS policy information to a session management function network element, to enable the session management function network element to configure QoS processing-related information to a processing device of the service data packet based on the QoS policy information.

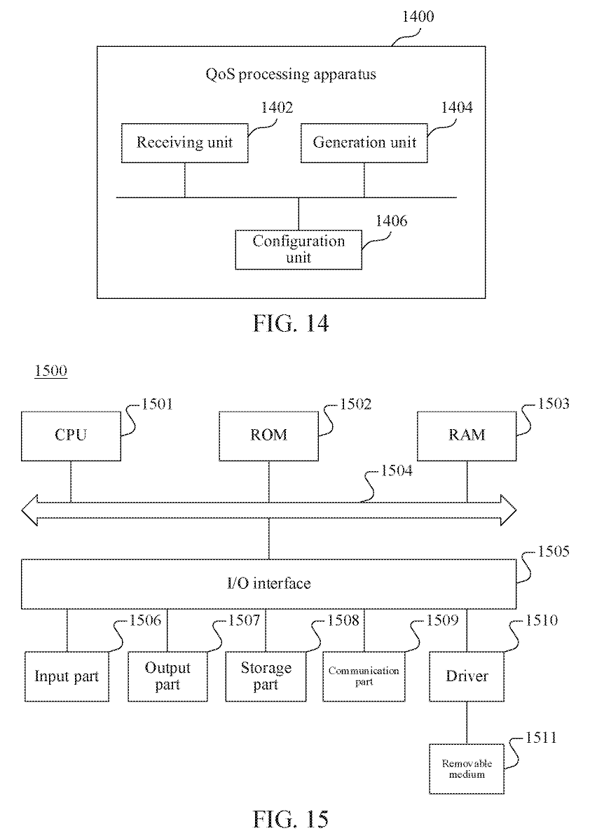

FIG. 14 is a block diagram of a QoS processing apparatus according to an embodiment of this application. The QoS processing apparatus is applied to an SMF, or may be applied to another network element.

Referring to FIG. 14, a QoS processing apparatus 1400 according to an embodiment of this application includes a receiving unit 1402, a generation unit 1404, and a configuration unit 1406.

The receiving unit 1402 is configured to receive QoS policy information that is transmitted by a policy control function network element and that is configured for processing a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device. The generation unit 1404 is configured to generate, based on the QoS policy information, QoS processing-related information corresponding to each processing device of the service data packet. The configuration unit 1406 is configured to configure the QoS processing-related information to the processing device of the service data packet.

In some embodiments of this application, based on the foregoing solution, the generation unit 1404 is configured to generate QoS processing-related information corresponding to each processing device of the service data packet based on at least one of the following manners:
generating QoS configuration information for the access network element based on a load that is received by the terminal device and that is of an uplink service data packet transmitted by the service processing device, the QoS configuration information being configured for indicating the access network element to configure a wireless transmission resource matching the load to the terminal device;
generating QoS configuration information for the access network element based on whether the terminal device has a data packet set processing capability, the QoS configuration information being configured for indicating whether the access network element performs downlink processing on a data packet set;
generating QoS rule information for the terminal device based on the load that is received by the terminal device and that is of the uplink service data packet transmitted by the service processing device, the QoS rule information being configured for configuring the wireless transmission resource matching the load to the terminal device;
obtaining latency information between the terminal device and the service processing device, and generating the QoS processing-related information based on the QoS policy information and the latency information; and
generating the QoS rule information for the terminal device based on a manner of reporting a QoS monitoring result and a QoS parameter included in the QoS policy information, the manner of reporting the QoS monitoring result including:
   combining monitoring results of a plurality of links for reporting or respectively reporting the monitoring results of the plurality of links.

FIG. 15 is a schematic structural diagram of a computer system suitable for implementing an electronic device according to the embodiments of this application. The electronic device may be the terminal device, the AF, the PCF, or the SMF in the foregoing embodiments.

A computer system 1500 of the electronic device shown in FIG. 15 is merely an example, and does not limit functions and the scope of usage of embodiments of this application.

As shown in FIG. 15, the computer system 1500 may include a central processing unit (CPU) 1501, and the central processing unit may perform various appropriate actions and processes based on a program stored in a read-only memory (ROM) 1502 or a program loaded to a random access memory (RAM) 1503 from a storage part 1508, for example, perform the method of the foregoing embodiments. Various programs and data needed for a system operation are stored in the RAM 1503. The CPU 1501, the ROM 1502, and the RAM 1503 are connected through a bus 1504. An input/output (I/O) 1505 is connected to the bus 1504.

The following components may be connected to the I/O interface 1505, including an input part 1506 of a keyboard, a mouse, and the like; including an input part 1507 of a cathode ray tube (CRT), a liquid crystal display (LCD), a speaker, and the like; including a storage part 1508 of hardware; and including a communication part 1509 of a network interface card such as a local area network (LAN) card, a modem, and the like. The communication part 1509 performs communication processing via a network such as the Internet. A driver 1510 is also connected to the I/O interface 1505 as needed. A removable media 1511, such as a magnetic disk, an optical disk, a magneto-optical disk, a semiconductor memory, and the like are installed on the drive 1510 as needed, so that it may be read that a computer program is installed to the storage part 1508 as needed.

Specifically, based on embodiments of this application, the process described foregoing with reference to the flowchart may be implemented as a computer software program. For example, an embodiment of this application includes a computer program product, and the computer program product is carried on computer program of a computer-readable medium. The computer program is configured to perform the method shown in the flowchart. In this embodiment, the computer program may be uploaded and installed from the network through the communication part 1509, and/or be installed from the removable media 1511. When the computer program is executed by the central processing unit (CPU) 1501, various functions limited in a system of this application are executed.

The computer-readable medium shown in embodiments of this application may be a computer-readable signal medium or a computer-readable storage medium, or any combination of the computer-readable signal medium and the computer-readable storage medium. The computer-readable storage medium may be, for example, but is not limited to, an electrical, magnetic, optical, electromagnetic, infrared, or a semiconductor system, apparatus or component, or any combination thereof. More specific examples of the computer-readable storage media may include, but are not limited to an electrical connection having one or more wires, a portable computer disk, a hard disk, a random access memory (RAM), a read-only memory (ROM), an erasable programmable read only memory (EPROM), a flash memory, fiber optics, a compact disc read-only memory (CD-ROM), an optical storage device, a magnetic storage device, or any appropriate combination thereof. In this application, the computer-readable storage medium may be any tangible medium that includes or stores a computer program. The computer program may be used by an instruction execution system, apparatus, or device, or may be used by a combination of the instruction execution system, apparatus, or device. However, in this application, the computer-readable signal medium may include a data signal propagated in a baseband or as a part of a carrier wave carrying the computer-readable computer program therein. The propagated data signal may use various forms, including but not limited to an electromagnetic signal, an optical signal, or any appropriate combination of thereof. The computer-readable signal medium may further be any computer-readable medium other than the computer-readable storage medium. The computer-readable medium may transmit, propagate, or transmit a program used by the instruction execution system, apparatus, or device or used with reference to the instruction execution system, apparatus, or device. The computer program included in the computer-readable media may be transmitted by using any appropriate medium, including but not limited to a wireless medium or a medium wired, or any appropriate combination of thereof.

Flowcharts and block diagrams in the drawings illustrate architectures, functions, and operations that may be implemented using the system, the method, and the computer program product according to various embodiments of this application. Each block in the flowchart or the block diagram may represent a module, a program segment, or a part of code. The module, the program segment, or the part of the code include one or more executable instructions for implementing specific logical functions. In some alternative implementations, the functions noted in the block may occur not in sequence noted in the drawings. For example, two blocks shown one after another may actually be executed substantially in parallel, or the two blocks may sometimes be executed in a reverse order. This depends on the functions involved. Each box in the block diagram or the flowchart and a combination of boxes in the block diagram or the flowchart may be implemented may using a dedicated hardware-based system configured to execute a specified function or operation, or may be implemented by using a combination of dedicated hardware and the computer program.

The units involved in embodiments of this application may be implemented in software or may be implemented in hardware, and the described units may also be provided in a processor. Names of the units do not constitute a limitation on the unit under some situations.

According to another aspect, this application further provides a non-transitory computer-readable storage medium. The computer-readable storage medium may be included in the electronic device described in embodiments, and may also exist alone without being assembled into the electronic device. The computer-readable storage medium carries, or has stored therein, one or more computer programs. When the one or more computer programs are executed by the electronic device, the electronic device implements the method described in the foregoing embodiments.

Although several modules or units of the device for action execution are mentioned in the foregoing detailed description, this division is not mandatory. Actually, based on the embodiments of this application, features and functions of two or more modules or units described above may be specified in one module or unit. On the contrary, the features and the functions of one module or unit described above may be further divided that is specified in one module or unit.

Through the foregoing description of the implementations, a person skilled in the art can easily understand that example embodiments described here may be implemented by software, or may be implemented by software combined with necessary hardware. Therefore, the technical solutions based on embodiments of this application may be implemented in a form of a software product. The software product may be stored in a non-volatile storage media (may be a CD-ROM, a USB flash disk, a hard disk, and the like) or on the network, including several instructions, so that an electronic device executes the method in the embodiments of this application.

For example, the electronic device may be the terminal device in the foregoing embodiment, and the terminal device may perform the QoS processing method shown in FIG. 3. For another example, the electronic device may be an AF, and the AF may perform the QoS processing method shown in FIG. 4. For another example, the electronic device may be a PCF, and the PCF may perform the QoS processing method shown in FIG. 5. For another example, the electronic device may be an SMF, and the SMF may perform the QoS processing method shown in FIG. 6.

A person skilled in the art can easily figure out another implementation solution of the implementation, the after considering the specification and practicing this application that is disclosed herein. This application is intended to cover any variations, uses or adaptive changes of this application. Such variations, uses or adaptive changes follow the general principles of this application, and include well-known knowledge and conventional technical means in the art that are not disclosed in this application.

This application is not limited to the precise structures described above and shown in the accompanying drawings, and various modifications and changes can be made without departing from the scope of this application. The scope of this application is subject only to the appended claims.

What is claimed is:

1. A quality of service (QoS) processing method, the QoS processing method being performed by a terminal device accessed to a core network through an access network element, the terminal device being in communication connection with a service processing device, the service processing device performing service interaction with a service server through the terminal device, and the QoS processing method comprising:
establishing a protocol data unit (PDU) session with the core network;
obtaining QoS rule information for the service processing device to transmit a service data packet with the service server based on the PDU session; and
performing QoS processing on a service data packet transmission process between the service processing device and the service server based on the QoS rule information.

2. The QoS processing method according to claim 1, wherein the establishing the protocol data unit PDU session with the core network comprises:
establishing the PDU session with the core network, service data packets of different service processing devices corresponding to different QoS flows in the PDU session;
respectively establishing PDU sessions corresponding to service data packets of different service processing devices with the core network; or
establishing the PDU session with the core network, service data packets of different service processing devices corresponding to a same QoS flow in the PDU session.

3. The QoS processing method according to claim 1, further comprising:
establishing, as an access point, a wireless local area network, the wireless local area network being configured to enable at least one service processing device to establish a communication connection between the terminal device and the at least one service processing device.

4. The QoS processing method according to claim 3, further comprising:
when the wireless local area network is not authenticated as trusted:
registering the wireless local area network with the core network, to authenticate the wireless local area network as a trusted wireless local area network; or
accessing the terminal device to the core network through the access network element.

5. The QoS processing method according to claim 3, further comprising:
allocating a network address to the service processing device after the service processing device is connected to the wireless local area network, to enable the service processing device to transmit the service data packet with the service server based on the allocated network address.

6. The QoS processing method according to claim 3, further comprising:
performing, after the service data packet transmitted by the service processing device to the service server is received, translation processing on a network address in the service data packet, to obtain a translated service data packet; and
transmitting the translated service data packet to the service server through the PDU session.

7. The QoS processing method according to claim 3, further comprising:
receiving a downlink service data packet from the service server; and
selecting, based on a priority of the downlink service data packet, a wireless local area network QoS mechanism corresponding to the priority, to transmit the downlink service data packet to the service processing device.

8. The QoS processing method according claim 1, further comprising:
receiving an uplink service data packet from the service processing device; and
transmitting a buffer status report to the access network element based on a quantity of uplink service data packets, to request the access network element to allocate an uplink transmission resource to the terminal device.

9. The QoS processing method according to claim 1, wherein the performing QoS processing on a service data packet transmission process between the service processing device and the service server based on the QoS rule information comprises:
discarding the corresponding service data packet in response to a monitoring, based on the QoS rule information, of an occurrence in the service data packet transmission process of at least one of:
congestion in the service data packet transmission process, transmission delay information of the service data packet being not capable of satisfying a latency requirement, a bit error rate of the service data packet being not capable of satisfying a bit error rate requirement, or the service data packet being determined as a useless redundant data packet.

10. The method according to claim 9, wherein the latency requirement is a latency requirement between the service server and the service processing device; and
the latency requirement is obtained based on latency information between the terminal device and the service processing device and latency information between the terminal device and the service server.

11. The QoS processing method according to claim 1, further comprising:
obtaining the latency information between the terminal device and the service processing device; and
when transmission delay of the service data packet between the service processing device and the service server is monitored, determining, based on the latency information, whether the transmission delay of the service data packet satisfies the latency requirement comprised in the QoS rule information.

12. The QoS processing method according to claim 1, further comprising:
obtaining the latency information between the terminal device and the service processing device; and
transmitting the latency information to a first core network element, to enable a policy control function network element to generate, based on the latency information obtained from the first core network element, QoS policy information configured for processing the service data packet, wherein
the QoS rule information is obtained based on the QoS policy information.

13. The QoS processing method according to claim 1, further comprising:
performing explicit congestion notification (ECN) marking on the service data packet monitored that congestion of the service data packet between the service processing device and the service server occurs.

14. The QoS processing method according to claim 1, further comprising:
performing QoS monitoring processing according to the QoS rule, to obtain a QoS monitoring result, the QoS monitoring result comprising at least one of the following: a monitoring result of a communication link between the terminal device and the service processing device, a monitoring result of a communication link between the terminal device and the access network element, and a monitoring result of a core network communication link; and
transmitting the QoS monitoring result to a second core network element, if the QoS monitoring result comprises monitoring results of a plurality of links, the monitoring results of the plurality of links being respectively transmitted to the second core network element, or the monitoring results of the plurality of links being combined and then the combined monitoring result being transmitted to the second core network element.

15. The QoS processing method according claim 1, further comprising:
transmitting, in response to monitoring that a data transmission rate of the communication link between the terminal device and the access network element is less than or equal to a set value, a notification message to a network element performing QoS monitoring processing; and
adjusting, in response to monitoring that a data transmission rate of the communication link between the terminal device and the service processing device is less than or equal to the set value, a communication channel between the terminal device and the service processing device.

16. A Quality of Service (QoS) processing method performed by an application function network element, the QoS processing method comprising:
generating QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device; and
transmitting the QoS requirement information to a policy control function network element, to enable the policy control function network element to generate, based on the QoS requirement information, QoS policy information corresponding to the service data packet.

17. The QoS processing method according to claim 16, wherein the generating the QoS requirement information for the service data packet comprises at least one of:
obtaining latency information between the terminal device and the service processing device, and generating the QoS requirement information based on the latency information; or
generating the QoS requirement information based on a manner of reporting a QoS parameter and a QoS monitoring result, the manner of reporting the QoS monitoring result comprising: combining monitoring results of a plurality of links for reporting or respectively reporting the monitoring results of the plurality of links.

18. A Quality of Service (QoS) processing method performed by a policy control function network element, the QoS processing method comprising:
obtaining QoS requirement information for a service data packet, the service data packet being a data packet transmitted between a service server and a service processing device, the service processing device being in communication connection with a terminal device, the terminal device being accessed to a core network through an access network element, and the service processing device performing service interaction with the service server through the terminal device;
generating, based on the QoS requirement information, QoS policy information corresponding to the service data packet; and
transmitting the QoS policy information to a session management function network element, to enable the session management function network element to configure QoS processing-related information to a processing device of the service data packet based on the QoS policy information.

19. The method according to claim 18, wherein the generating, based on the QoS requirement information, the QoS policy information corresponding to the service data packet comprises at least ones:
obtaining latency information between the terminal device and the service processing device, and generating the QoS policy information based on the QoS requirement information and the latency information; or
generating the QoS policy information based on a manner of reporting a QoS monitoring result and a QoS parameter comprised in the QoS requirement information, the manner of reporting the QoS monitoring result comprising: combining monitoring results of a plurality of links for reporting or respectively reporting the monitoring results of the plurality of links.
